(19) United States
(12) Patent Application Publication
(10) Pub. No.: US 2018/0262026 A1
(43) Pub. Date: Sep. 13, 2018

(54) Battery System With Short Circuit Protection

(71) Applicant: K2 Energy Solutions, Inc., Henderson, NV (US)

(72) Inventors: David Gurtner, Las Vegas, NV (US); Scott Stewart, Henderson, NV (US); Gilbert De Guzman, Henderson, NV (US)

(21) Appl. No.: 15/456,020

(22) Filed: Mar. 10, 2017

(51) Int. Cl. H02J 7/00

(52) U.S. Cl. CPC H02J 7/0031; H02J 2007/0067; H02J 7/0063

(57) ABSTRACT

A battery system with short circuit protection is disclosed. The battery system comprises a positive output terminal and a negative output terminal, and a battery pack coupled to the output terminals. The battery pack provides a substantially constant output voltage across the output terminals as the battery pack is substantially discharged. The battery system further comprises a battery management system and a voltage sensor coupled to the battery management system for providing a voltage signal to the battery management system representative of the output voltage across the positive output terminal and the negative output terminal. The battery system further comprises a switching device operatively coupled to the battery management system. The battery management system monitors the sensor signal and opens the switching device when the sensed voltage drops below a threshold voltage, disconnecting the battery pack from the output terminals.

### FIELD OF THE INVENTION

The present invention relates to a battery system comprising a battery pack, such as a lithium-ion battery pack, and a battery management system, the battery management system including circuitry for detecting a short circuit across the output terminals of the battery system and disconnecting the battery pack from the detected short circuit.

### BACKGROUND

In order to protect a battery and connected equipment from damage due to a short circuit, and to protect users from possible harm, it is common practice to protect a battery with a fuse. When a short circuit occurs across the output terminals of the battery, excessive current flowing through the fuse causes the fuse to open, disconnecting the battery from the short circuit. In order to make the battery operational again, the blown fuse must be replaced. For high current applications, the fuse must be properly sized so that the fuse remains closed during normal high current conditions, but opens only due to a short circuit.

Certain types of battery cells, such as lead acid battery cells, exhibit a generally linearly decreasing discharge curve as the battery cell discharges. However other types of battery cells, such as conventional lithium-ion battery cells, exhibit a generally constant output voltage during discharge, until the lithium-ion battery cell is substantially discharged.

Depending upon the particular chemistry of a particular lithium-ion battery cell, the lithium-ion battery cell may have a nominal output voltage between 3.2 volts and 4.2 volts. Such lithium-ion battery cells may have a relatively flat discharge curve until they reach substantial discharge, at which point the output voltage may rapidly decrease. Conventional lithium iron phosphate battery cells may have a relatively flat discharge curve generally of the order of 3.2-3.4 volts. See for example FIG. 1.

When a short circuit is presented across the output terminals of certain battery cells, such as lithium-ion battery cells, the output voltage of the battery cells rapidly decreases, approaching zero volts. While in certain applications, one could potentially monitor for short circuit conditions by monitoring for rapid dv/dt conditions, when powering high current loads, it is often difficult to distinguish a rapid dv/dt caused by a short circuit from a similar, rapid dv/dt caused by the application of a high current load.

### SUMMARY

The scope of the present invention is defined solely by the appended claims and detailed description of a preferred embodiment, and is not affected to any degree by the statements within this summary.

It is an object to provide a battery system with short circuit protection. The battery system may comprise a positive output terminal and a negative output terminal. The battery system may further comprise a battery pack coupled to the positive output terminal and the negative output terminal. The battery pack may exhibit a substantially constant output voltage across the positive output terminal and the negative output terminal as the battery pack is substantially discharged. The battery system may further comprise a voltage monitor for monitoring the output voltage of the battery pack and a switch responsive to the voltage monitor means for disconnecting the battery pack from the battery system terminals when the monitored output voltage drops below a threshold voltage.

It is a further object to provide a method of disconnecting a battery pack from output terminals of a battery system. The battery pack may exhibit a substantially constant output voltage across the output terminals as the battery pack is substantially discharged. The method may comprise monitoring the output voltage of the battery pack and disconnecting the battery pack from the battery system terminals when the monitored output voltage drops below a threshold voltage.

These and other objectives and advantages of the present invention will become apparent from the following description taken in conjunction with the accompanying drawings wherein are set forth, by way of illustration and example, a certain embodiment of the instant invention.

### BRIEF DESCRIPTION OF THE DRAWINGS

For a more complete understanding of the disclosure, reference should be made to the following detailed description and accompanying drawings, wherein:

FIG. 1 is a discharge curve, for various discharge rates, for a typical lithium-ion battery cell;

FIG. 2 is a block diagram of a battery system in accordance with the present invention;

FIG. 3 is a more detailed drawing illustrating the battery system of FIG. 2; and

FIG. 4 is a flow chart illustrating operation of the battery system of FIG. 2.

### DESCRIPTION OF THE PREFERRED EMBODIMENT

It is to be understood that this disclosure is not intended to limit the invention to any particular form described, but to the contrary, the invention is intended to include all modifications, alternatives and equivalents falling within the spirit and scope of the invention as defined by the appended claims.

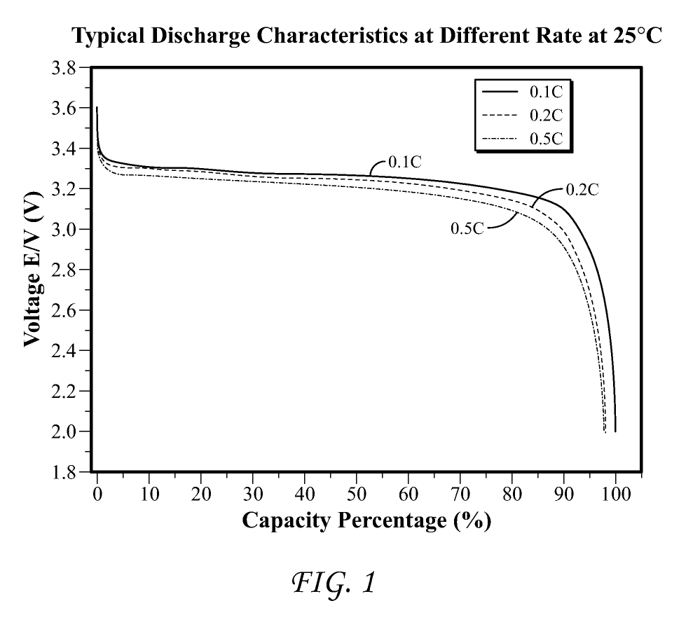

A discharge curve for a typical lithium-ion battery cell, such as a lithium iron phosphate battery, is illustrated in FIG. 1. As shown, the output voltage may remain substantially constant, in the range of approximately 3.4 volts, dropping to approximately 3.0 volts, as the lithium ion battery cell discharges about 90% of its capacity, even as the rate of discharge increases. The output voltage may remain above approximately 2.5 volts even after approximately 95% discharge.

As described above, in the event of a short circuit condition across a load coupled to the battery cell, the output voltage substantially immediately drops, approaching zero volts. Thus by monitoring the magnitude of the output voltage of the battery cell, or of a group of battery cells arranged as a battery pack, and determining when the output voltage has dropped below a threshold voltage, one may detect a short circuit and open a contactor disconnecting the battery cell/battery pack from the short circuit. One may then also subsequently manually and/or automatically reconnect the battery cell/pack to the load, detecting whether or not the short circuit has been removed.

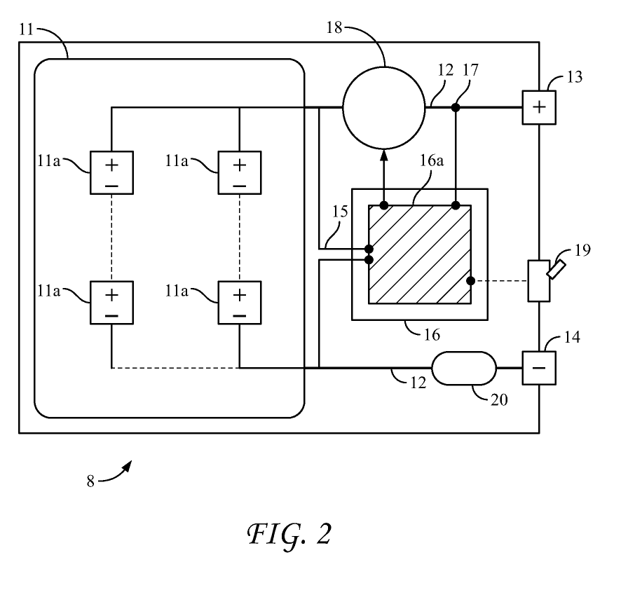

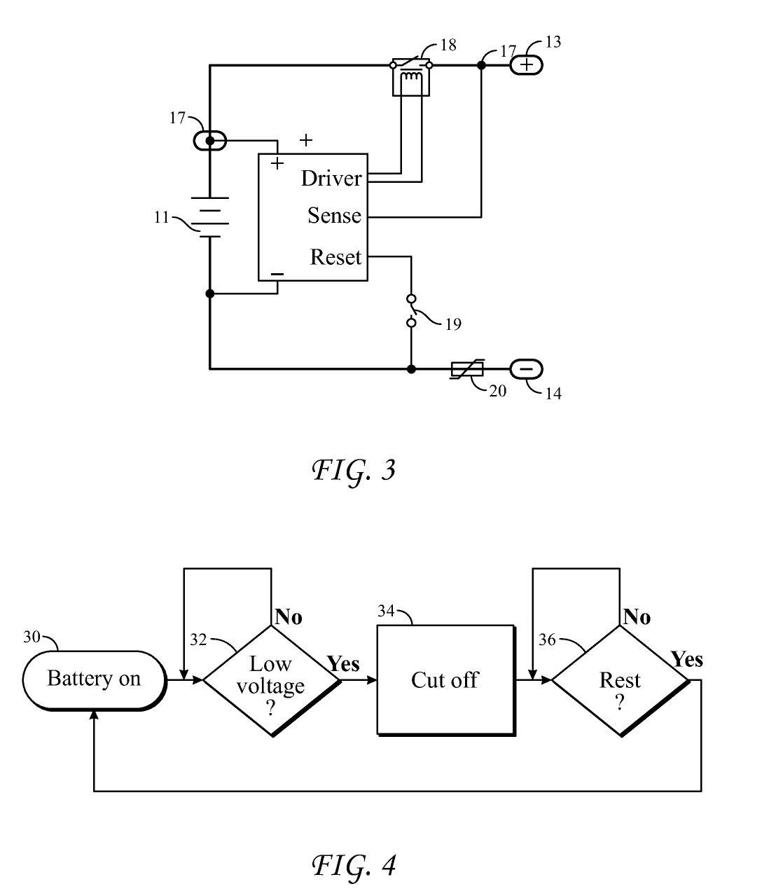

A battery system, generally designated 8, in accordance with the present invention, is illustrated in FIGS. 2 and 3. The battery system 8 may include a battery pack 11. The battery pack 11 may include one or more battery cells of a type exhibiting a substantially flat discharge curve, such as conventional lithium-ion battery cells 11a. In the present embodiment, the lithium-ion battery cells may be lithium iron phosphate battery cells.

The lithium-ion battery cells 11a may have a nominal output voltage of 3.2 volts, although it is understood the battery cells 11a may have other nominal output voltages, such as in the range of 3.2 volts-4.2 volts, depending upon the particular chemistry, and other factors, of the particular battery cells 11a.

As is well known, the battery cells 11a may be interconnected serially and/or in parallel such that the battery pack 11 may provide output power at a desired output voltage and capacity via wires or bus bars 12 to a conventional positive terminal 13 and a negative terminal 14. The battery pack 11 may be an Extreme Angler Marine lithium-ion Battery Pack, provided by K2 Energy Solutions, Inc., Henderson NV, assignee of the present application. The battery pack 11 may have four 3.2 volt battery cells 11a arranged in series, providing a nominal output voltage of the battery pack 11 of 12.8 volts.

The battery system 8 may also include a battery management system including a control board 16. The control board 16 may include a conventional, programmed central processing unit (CPU) 16a, such as a conventional microprocessor and associated memory, programmed to perform functions described herein. The microprocessor may be an STM32L051, provided by STMicroelectronics, Geneva, Switzerland.

The battery pack 11 may provide power through connections 15 to the control board 16.

The control board 16 may be coupled to a conventional voltage sensor 17, disposed between the positive terminal 13 and the negative terminal 14. The voltage sensor 17 may be a conventional switched voltage divider circuit. The control board 16 may be coupled to the voltage sensor 17, either directly or through other components, as is well known. The voltage sensor 17 measures the voltage level between the positive terminal 13 and the negative terminal 14. The control board may also be coupled to a conventional switching device, such as a conventional contactor 18. The contactor 18 may cut off one or both of the terminals 13, 14, of the battery pack 11, upon command of the CPU 16a when the sensed voltage level drops below a threshold voltage, thereby removing the battery pack 11 from any associated load.

The control board 16 may also be coupled to an optional switch 19, which may be user operable. The switch 19 may provide a signal to the CPU 16a to reset the short circuit cutoff, causing the CPU 16a to close the contactor 18.

The control board 16 may also be coupled to an optional fuse 20, which may be used as a backup cutoff device.

The threshold voltage may be stored in the memory of the CPU 16a. The threshold voltage may be a level substantially below the nominal output voltage of the battery pack 11.

The particular threshold voltage may depend upon the particular anticipated application of the battery pack 11. For a power application, the threshold voltage may be set at a lower value than for an energy application, as power applications may cause more short-term voltage drops, which should not be confused with a short circuit condition.

For the battery pack 11a of the present embodiment having a nominal output voltage of 12.8 volts, for use in an energy application, the threshold voltage may be set at 62.5% of its nominal output voltage, or 8 volts.

For the battery pack 11a of the present embodiment having a nominal output voltage of 12.8 volts, the threshold voltage may be set at a lower value, such as 7.8 volts.

It is to be understood that the threshold voltage may be any voltage sufficiently below the normal operating the voltage of the particular battery pack, so as not to disconnect the output terminal during normal operation of the battery system 8.

In accordance with the present invention, the CPU 16a may periodically sample the voltage sensor 17, indicative of the voltage across the positive and negative voltage terminals 13, 14, respectively. Sampling by the CPU 16a may be done every 1 msec. As described above, in the event of a short circuit, the voltage across the voltage sensor 17 will drop sharply, to a level below the stored threshold voltage. When the CPU 16a detects the sensed voltage has dropped below the threshold voltage (8.0 volts in the present example), the CPU 16a may open the contactor 18. In the present embodiment, for a fast response, the CPU 16a may respond to a single, sensed occurrence of the sensed voltage dropping below the threshold voltage, causing the CPU 16a to open the contactor 18. Alternatively the CPU 16a may respond to an average of a series of samples, or respond to a certain number of samples below the threshold voltage, before opening the contactor 18.

The CPU 16a may close the contactor 18 after a certain amount of time, such as to automatically check whether the condition causing the short circuit has been corrected. Alternatively a user may press the reset switch 19, which may cause the CPU 16a close the contactor 18. Additionally, the CPU 16a may close the contactor 18 when the CPU 16a detects a charge voltage has been applied to the battery pack 11. In any case, if a short circuit still exists while attempting to reset the controller 18, the short circuit may again be detected by the CPU 16a, as described above, again reopening the contactor 18.

A flow chart illustrating one aspect of operation of the CPU 16a is illustrated in FIG. 3.

In a first step 30, the battery system 8 may be turned on, such as by the switch 19. The CPU 16a may then begin sampling the voltage sensor 17 in a step 32. Once the CPU 16a determines the voltage across the voltage sensor 17 is below the stored threshold voltage for a determined period of time, the CPU 16a, in a step 34, may open the contactor 18.

In step 36, the switch 19, which may be in the form of a button, touchpad or keyed switch, may reset the cutoff. The CPU 16a may be programmed to automatically close the contactor 18 reset after a set time, or after some other input to the CPU 16a.

The battery system may have one or more fuses 20 for backup in case the control board 16 fails or the contactor 18 fails to open. Instead of, or in addition to, the fuse 20, the battery system 8 may include a circuit breaker, PTC or other resettable cutoff device, or a fusible link or other non-resettable cutoff device.

The contactor 18 may include an auxiliary connection coupled to an input to the CPU 16a to verify whether the contactor 18 is open or closed. Instead of the contactor 18, a relay or transistor or other switching device may be used. The battery system 8 could incorporate additional switching to the current flow instead of cutting it off, such as what is commonly referred to as “precharge” or “equalization” circuitry. Any of the devices may be in line of the positive terminal, the negative terminal, or both.

The battery system 8 may include a conventional thermistor for measuring a temperature representative of battery temperature. The measured battery temperature may be used for various battery management purposes. The CPU 16a may be programmed to adjust the threshold voltage based upon the sensed battery temperature, such as by lowering the threshold voltage upon detection of a cold battery pack.

A preferred embodiment of this invention has been described herein. It should be understood that the illustrated embodiment is exemplary only and should not be taken as limiting the scope of the invention.

What is claimed is:

1. A battery system with short circuit protection comprising:
a positive output terminal and a negative output terminal;
a battery pack coupled to the positive output terminal and the negative output terminal, the battery pack providing a substantially constant output voltage across the positive output terminal and the negative output terminal as the battery pack is substantially discharged;
a battery management system;
a voltage sensor coupled to the battery management system for providing a voltage signal to the battery management system representative of the output voltage across the positive output terminal and the negative output terminal; and
a switching device operatively coupled to the battery management system;
wherein the battery management system monitors the voltage signal and opens the switching device when the sensed voltage drops below a threshold voltage, disconnecting the battery pack from the positive output terminal and the negative output terminal.

2. The battery system of claim 1 wherein the switching device comprises a contactor.

3. The battery system of claim 1 wherein the voltage sensor is disposed between the positive output terminal and the negative output terminal of the battery pack.

4. The battery system of claim 1 wherein the battery pack comprises a plurality of lithium-ion battery cells.

5. The battery system of claim 1 wherein the battery management system includes a central processing unit for monitoring the voltage signal and opening the contactor when the sensed voltage drops below the threshold voltage.

6. The battery system of claim 5 wherein the central processing unit comprises a microprocessor.

7. The battery system of claim 5 wherein the central processing unit:
periodically samples the voltage sensor; and
opens the contactor when a single sample of the sensed voltage drops below the threshold voltage.

8. The battery system of claim 5 wherein the central processing unit:
periodically samples the voltage sensor;
averages over time a plurality of the samples of the sensed voltages; and
opens the switching device when the average of the plurality of the samples of the sensed voltages drops below the threshold voltage.

9. The battery system of claim 5 wherein the central processing unit:
periodically samples the voltage sensor; and
opens the contactor when a threshold number of samples of the sensed voltages drop below the threshold voltage.

10. The battery system of claim 9 wherein the threshold number of the samples of the sensed voltages consists of a threshold number of sequential samples.

11. The battery system of claim 1 including a thermistor for measuring a temperature representative of a temperature of the battery pack, wherein the threshold voltage is adjusted in accordance with the measured temperature.

12. A battery system with short circuit protection comprising:
a positive output terminal and a negative output terminal;
a battery pack coupled to the positive output terminal and the negative output terminal, the battery pack exhibiting a substantially constant output voltage across the positive output terminal and the negative output terminal as the battery pack is substantially discharged;
means for monitoring the output voltage of the battery pack; and
means responsive to the monitoring means for disconnecting the battery pack from the battery system terminals when the monitored output voltage drops below a threshold voltage.

13. The battery system of claim 12 wherein the monitoring means comprises a voltage sensor disposed between the positive output terminal and the negative output terminal of the battery pack.

14. The battery system of claim 12 wherein the battery pack comprises a plurality of lithium-ion battery cells.

15. The battery system of claim 12 wherein the disconnecting means:
periodically samples the monitoring means; and
disconnects the battery pack from the battery system terminals when a single sample of the monitoring means drops below the threshold voltage.

16. The battery system of claim 12 wherein the disconnecting means:
periodically samples the monitoring means;
averages over time a plurality of the samples; and
disconnects the battery pack from the battery system terminals when the average of the plurality of the samples drops below the threshold voltage.

17. The battery system of claim 12 wherein the disconnecting means:
periodically samples the monitoring means; and
disconnects the battery pack from the battery system terminals when a threshold number of the samples of the sensed voltages drop below the threshold voltage.

18. The battery system of claim 17 wherein the threshold number of the samples consists of a threshold number of sequential samples.

19. For a battery system having a battery pack coupled to a positive output terminal and a negative output terminal, the battery pack exhibiting a substantially constant output voltage across the positive output terminal and the negative output terminal as the battery pack is substantially discharged, a method of disconnecting the battery pack from the output terminals, the method comprising:
monitoring the output voltage of the battery pack; and
disconnecting the battery pack from the battery system terminals when the monitored output voltage drops below a threshold voltage.

20. The method of claim 19 wherein the battery pack comprises a plurality of lithium-ion battery cells.

21. The method of claim 19 including:
periodically sampling the output voltage of the battery pack; and
disconnecting the battery pack from the battery system terminals when a single sample drops below the threshold voltage.

22. The method of claim 19 including:
periodically sampling the output voltage of the battery pack;
averaging a group of sampled output voltages; and
disconnecting the battery pack from the battery system terminals when the average of the group of samples drops below the threshold voltage.

23. The method of claim 19 including:
periodically sampling the output voltage of the battery pack; and
disconnecting the battery pack from the battery system terminals when a threshold number of the samples drop below the threshold voltage.

24. The method of claim 23 wherein the threshold number of the samples consists of a threshold number of sequential samples.
